(19) United States
(12) Patent Application Publication
(10) Pub. No.: US 2007/0183112 A1
(43) Pub. Date: Aug. 9, 2007

(54) Spark gap arrestor

(76) Inventor: Kojiro Kato, Kanagawa (JP)

Correspondence Address: YOUNG & THOMPSON, 745 SOUTH 23RD STREET, 2ND FLOOR, ARLINGTON, VA, 22202, US

(21) Appl. No.: 10/588,075

(22) PCT Filed: Jan. 26, 2005
(86) PCT No.: PCT/JP05/00991

§ 371 Date: Sep. 7, 2006

(30) Foreign Application Priority Data
Feb. 2, 2004 (JP) 2004-025367

(51) Int. Cl. H02H 9/06

(52) U.S. Cl. 361/118

(57) ABSTRACT

[Problem] To realize a spark gap arrester of a sealed structure in which a follow current is eliminated by increasing voltage drop independent of an arc current and thereby preventing restrike due to a power-supply voltage after passage of a lightning current. [Means for Resolution] In a cylindrical metal case housing a spark gap, plural magnetic material metal rings concentric with a conical or columnar electrode constituting the spark gap are arranged as arc-suppressing plates. An arc generated by passage of a lightning current is led to the arc-suppressing plate on the outer periphery, and restrike due to a power-supply voltage after passage of a lightning current is prevented by an arc voltage generated on both sides of the arc-suppressing plate.

### TECHNICAL FIELD

This invention relates to an arrester structure that is installed in a low-voltage AC power circuit and adapted for bypassing and discharging a lightning current to the ground in order to protect an electronic device sensitive to overvoltage when lightning strike occurs.

### BACKGROUND ART

After the Franklin lightning conductor was invented in the late 1700s, lightning conductors and conductor wires were exclusively used as devices for protecting buildings from lightning for about 200 years (external protection from lightning). This is because damage could be minimized by receiving a lightning stroke current by these conductors and discharging it to the ground at the shortest distance via a grounding electrode. As distribution lines and telephone lines began to spread in the early 1900s, many accidents occurred in which insulating parts of electric and communication devices are broken by a lightning current that flowed into a building via these electric wires or a lightning current that flowed into the grounding on the outside of the building via these electric wires when lightning struck the building. Particularly recently, since the degree of spreading of electronic devices is increased and they serve as the central parts of economy, transportation, electric power, communications and production management, preventive measures against system down due to lightning strike is an important technical problem.

As a method for preventing an accident due to a lightning current flowing into a building or a lightning current flowing out of a building, it is proposed as best to electrically connect the principal metal parts (for example, steel frames, steel rods and the like) of the basic structure of the building to form basic grounding, provide a single or plural grounding buses within the building, connect the grounding buses to the basic grounding at the shortest distance, and electrically connect all the metal pipes (for example, water pipe, gas pipe and the like) and electric wires (distribution lines, telephone lines, antenna lines and the like) led in from outside, to a bonding bar near the entrance (equipotential bonding). This was standardized in Germany in 1987 (non-patent reference 1). This standard was employed as an international standard, with its contents substantially unchanged (non-patent reference 2). Also in Japan, a new standard in conformity to the above-mentioned IEC standard was established (non-patent reference 3).

With respect to lightning current at the time of lightning strike, the international standard (non-patent reference 4) presents the current values, waveforms and quantities of electric charges shown in Table 1.

TABLE 1

| | Protection level³⁾ | | |
|---|---|---|---|
| Current parameter | I | II | III-IV |
| Crest value I (kA) | 200 | 150 | 100 |
| Duration of wave front T₁ (μs) | 10 | 10 | 10 |
| Duration of wave tail T₂ (μs) | 350 | 350 | 350 |
| Discharging charges Qₛ¹⁾ (C) | 100 | 75 | 50 |
| Intrinsic energy W/R²⁾ (MJ/Ω) | 10 | 5.6 | 2.5 |

¹⁾Since the majority of the entire charges Qₛ is included in the first lightning stroke, the entire discharging charges coincide with the presented values.
²⁾Since the majority of the intrinsic energy W/R is included in the first lightning stroke, the intrinsic energy of all the discharges coincides with the presented values.
³⁾The protection level is decided by the frequency of lightning strike and the importance of the building to be protected (level I > II > III > IV).

The crest value I of lightning current of 100 to 200 kA and the duration of wave tail T2 of 350 μs were values largely exceeding the conventionally expected values. The change of the reference waveform clarifies on one hand that the conventional arrester burns and explodes relatively easily at the time of lightning strike and does not serve as intended as the arrester, and suggests on the other hand that large increase in the amount of impulse current resistance of the lightning current arrester is necessary.

FIG. 1 shows an example in which internal protection from lightning prescribed in non-patent reference 3 is applied to a low-voltage distribution system of a typical building. When lightning strikes a point 31 of a building 10, a lightning current 32 is discharged to the ground (lightning current 33) via a metal structure or a lightning conductor wire of the building. However, rise in the potential of the whole building occurs because of a building base grounding resistance R1. For example, if R1 is 10 Ω and 50 kA of the lightning current crest value 100 kA flows through R1, the potential of the whole building is 500 kV. Since a bonding bar 11 connected to the building base grounding has the same potential, which highly exceeds the normal potential of the low-voltage distribution line (approximately 300 V or less with respect to the ground), an arrester 12 breaks over and a part of the lightning current (lightning current 34) flows. The lightning current 34 flows through each conductor wire of the distribution lines (lightning current 35), and is ultimately discharge to the ground (lightning current 36) via a grounding resistance R2 from a neutral point of a secondary winding 21 of a distribution transformer 20. If it is assumed that R1 is approximately equal to R2, the splitting ratio of the lightning currents 33 and 36 is substantially 1:1 and the crest value of impulse current per electrode of the arrester 12 is considered to be approximately ⅙ of the lightning current 32 (about 17 kA if the lightning current crest value is 100 kA). Therefore, the lightning current arrester installed at the distribution line entrance need to have an amount of impulse current resistance equal to or more than 20 kA in the case of an impulse current waveform of 10/350 μs.

The arrester that has been conventionally used most often in order to limit the overvoltage generated in distribution lines is a device including varistor device made of zinc oxide, as a principal element. The current and voltage waveforms when an impulse current flows through the zinc oxide varistor are shown in FIG. 2. The zinc oxide varistor has no delay due to limitation of overvoltage with respect to an impulse current having a high rising speed, and the ratio of the discharge voltage to the maximum value of power-supply voltage (discharge voltage/maximum value of power-supply voltage) can be set at a relatively small value, and it clamps at a higher voltage value than the maximum value of power-supply voltage. Therefore, the zinc oxide varistor is an excellent device for protection from overvoltage in that there is no risk of follow current from the power circuit after the impulse current vanishes.

However, as shown in FIG. 2, since the varistor terminal voltage is maintained at several hundred V during the energization with the impulse current, the quantity of energy conversion within the varistor is large, and the varistor easily breaks and explodes particularly in the case of an impulse current having a long duration of wave tail. Therefore, it cannot be used as a lightning current arrester.

Table 2 shows the relation between the threshold load value of the varistor (it can be loaded once without being broken) with respect to an impulse current of 10/350 μs and the diameter of the varistor.

TABLE 2

| Diameter of metal oxide varistor mm | Threshold load kA (10/350 μs) |
|---|---|
| 32 | 1 |
| 40 | 2 |
| 60 | 3 |
| 80 | 5 |

It can be understood that only an amount of resistance that is ¼ required amount of impulse current resistance of 20 kA is acquired even if a large varistor with a diameter of 80 mm is used.

An arrester including a spark gap as a principal element has an overvoltage switching characteristic by nature (see FIG. 3). When the overvoltage value exceeds the discharge starting voltage of the gap, the spark gap breaks over and starts arc discharge. The arc voltage is approximately several ten V, and the quantity of energy conversion within the arrester when a lightning discharge current flows, is small. Therefore, by selecting a material and structure that can resist high temperatures, it is possible to realize practical use of the spark gap as a lightning current arrester.

However, in order to realize practical use of the spark gap as a lightning current arrester, there are two technical problems to be solved.

1) After a lightning impulse current vanishes, a follow current flows from the power circuit through the ionized air path. If this follow current is intercepted by an external protection circuit, inconvenience occurs such as the loss of the protective function against overvoltage due to shutdown of power supply to the load circuit or shutdown of the spark gap arrester from the power line.

2) When a large lightning impulse current flows, the air on the periphery of the aerial arc discharge path is heated and ionized and thus explosively expands and erupts, thereby affecting the peripheral wiring and equipment.

The problem 2) is solved by the technique of patent reference 1. FIG. 4 shows the basic structure of the spark gap arrester disclosed in reference 1. All the components are arranged in a rotationally symmetrical structure about a center axis. Two main electrodes 1a and 1b face each other, with a predetermined gap held between them by a columnar insulator 2. When an impulse voltage exceeding the withstand voltage of this gap is applied, spark discharge starts in the gap and shifts to arc discharge. Large-current arc discharge causes quick ionization and expansion of the air in the inner space of the arrester. However, since the outer side of a case formed by a cylindrical insulator 3, heat insulating plates 4a, 4b and lid members 5a, 5b is covered with a metal pipe 6 and its both sides are firmly closed by curling processing, no explosion or damage occurs even if the internal pressure exceeds several tens atmosphere. The duration of the impulse current is 1 ms or less, which is a short time, and the heat capacity of the metal components is sufficiently large. Therefore, excessive temperature rise does not occur. Thus, the foregoing problem 2) is solved by this sealed structure. In the drawing, 7a and 7b are led-out conductors screwed into the electrodes 1a and 1b.

It cannot be said that the foregoing problem 1) is completely solved by the above-described structure of patent reference 1. It is because an arc voltage is dependent on an arc current and the following equation generally holds under the condition of constant pressure.
U_{B}=(U_{A}+U_{K})+R_{B}*I_{B}

Here, U_{B} is arc voltage, U_{A}+U_{K} is anode voltage drop plus cathode voltage drop, R_{B} is arc resistance, and I_{B} is arc current.

FIG. 5 shows the relation between the arc current I_{B} and the arc voltage U_{B}. Although the slope of the relational line changes as indicated by a, b, c and d when the arc resistance R_{B} is changed by the atmospheric pressure, arc length and the like, the voltage (U_{A}+U_{K}) at the current-zero point does not change. The value of (U_{A}+U_{K}) is a substantially constant value of approximately 60 V, which is not affected by the pressure, temperature and the like.

FIG. 6 shows the waveform of a follow current in the case where an impulse current follow the arrester with a power-supply voltage of 220 V and a phase angle 60° (instantaneous voltage value of approximately 270 V). When the impulse current is reduced to substantially zero, if the arc voltage is substantially equal to the power-supply voltage, no follow current is generated. However, if the arc voltage is the above-described (U_{A}+U_{K})=60 V, the follow current cannot be prevented.

When the power circuit impedance and/or the arc resistance R_{B} is relatively large, the current waveform of follow current 1 appears. Since the power restriking voltage at the current-zero point is 60 V or less, the follow current vanishes at this point. However, when the power circuit impedance and the arc resistance are small, the current waveform of follow current 2 appears. Since the power restriking voltage at the current-zero point is 60 V or more, the arc restrikes and the follow current continues.

Patent Reference 1: Specification of Laid-Open European Patent Application No. 78434

Non-Patent Reference 1: DIN VDE 0185, Part 100, “Prescriptions and general principles with respect to protection of buildings against lightning”

Non-Patent Reference 2: IEC 61024-1 (1990), “Protection of structures against lightning, Part 1”

Non-Patent Reference 3: JIS A 4201-2003, “Protection of architectures against lightning”

Non-Patent Reference 4: IEC 61312-1 (1995), “Protection against lightning electromagnetic impulse, Part 1, General principles”

### DISCLOSURE OF THE INVENTION

Problems that the Invention is to Solve

Thus, an object of this invention is to realize a spark gap arrester of a sealed structure in which restrike after passage of a lightening current is prevented, generating no follow current.

Means for Solving the Problems

A voltage drop independent of an arc current is provided by inserting a metal plate into an arc discharge path to split the arc and then generating anode and cathode voltage drops on both sides of the metal plate. Since the voltage drop acquired by a pair of anode and cathode electrodes is about 60 V, if a power-supply voltage of 200 V is assumed, at least four metal plates must be added in order to acquire a voltage drop of 300 V.

When a conductor is arranged near a magnetic material plate and a current is flowed through the conductor, an attraction force acts between the magnetic material plate and the conductor. This is because magnetic fluxes generated by the current are usually concentric about the conductor, whereas if there is a magnetic material having high permeability near the conductor, the majority of the magnetic fluxes are concentrated within the magnetic material and the magnetic flux density of the magnetic material-side part of the conductor is lowered. This attraction force becomes zero if the conductor shifts to the center of the magnetic material plate. In this invention, this principle is applied and an arc generated between the two discharge electrodes at the time of lightning strike is shifted into a grid structure of arc-suppressing plates, thus suppressing the arc.

Moreover, as auxiliary means for shifting the arc discharge path, it is effective to arrange an arc-suppressing insulating material (polyacetal, polypropylene or the like) and utilize arc-suppressing gas that erupts because of thermal decomposition of the above-mentioned insulating material when an arc is generated.

Advantage of the Invention

According to the structure of this invention, excellent advantages as follows can be provided.
In a spark gap arrester arranged within a cylindrical metal case, as plural magnetic material metal rings concentric with a circular cross section of a conical or columnar electrode are arranged as arc-suppressing plates, anode and cathode voltage drops of an arc generated by a lightning impulse current and/or a power circuit follow current are increased and the follow current self-intercepting performance independent of the power-supply impedance is provided.
According to one embodiment of this invention in which proximal parts of two discharge electrodes are made of an ordinary conductive material such as copper or brass and only their distal end parts are made of a heat-resistant and arc-resistant material such as copper-tungsten or silver-tungsten, the function of the arrester can be guaranteed while the material cost is restrained.
According to a developed form of the foregoing embodiment in which a recessed part is provided in the proximal part of the electrode and a protruding part of the distal end part of the electrode is pressed into the recessed part, troublesome works such as soldering materials of different types can be avoided. Since a compression force is constantly applied to the electrode by the metal case, separation of the proximal part and the distal end part does not occur.
According to another embodiment of this invention in which the whole body except the distal end part and the proximal part of the conical or columnar electrode is covered with an organic arc-suppressing insulating material, extension of the arc discharge path is promoted and the follow current self-intercepting performance is enhanced.
According to still another embodiment in which a recessed part is provided on each of end surfaces facing each other of two discharge electrodes, with an insulator inserted across the two recessed parts, and the dimension of a spark gap is defined by the difference between the sum of the depths of the two recessed parts and the thickness of the insulator, the gap dimension can be prescribed with high accuracy while the assembling work is simplified.
According to another embodiment in which a ring-shaped disc made of an organic arc-suppressing insulating material and having a step-like cross section is inserted as a spacer between plural ring-shaped arc-suppressing plates, the arc-suppressing plates are insulated from the metal case and fixed, and arc discharge is prevented from transferring to the metal case.
According to still another embodiment in which arc-suppressing plates are arranged over a part that is not covered with an organic arc-suppressing insulating material between the distal end parts and the proximal parts of the two discharge electrodes, an arc generated between the two discharge electrodes can be completed shifted to the arc-suppressing plate and reliable arc suppression can be realized.
As an inorganic reinforcement is added to the organic arc-suppressing insulating material, the heat resistance and the mechanical strength can be enhanced without lowering the arc-suppressing performance of the components.
As an air gap is provided to reduce residual magnetism of the magnetic material metal rings used as arc-suppressing plates, the permeability of the magnetic material can be improved and the attraction force to the arc discharge path can be increased.

### BRIEF DESCRIPTION OF THE DRAWINGS

FIG. 1 shows an internal protection circuit against lightning in a low-voltage distribution system of a typical building, prescribed by JIS A 4201-2003.

FIG. 2 shows current and voltage waveforms of a zinc oxide varistor.

FIG. 3 shows current and voltage waveforms of a spark gap.

FIG. 4 shows the structure of a conventional sealed spark gap arrester.

FIG. 5 shows current and voltage characteristics of arc discharge.

FIG. 6 shows impulse current and follow current waveforms in an AC power circuit.

FIG. 7 shows a sectional view of a self-arc-suppressing arrester according to this invention.

FIG. 8 shows an air gap provided in a magnetic material metal ring.

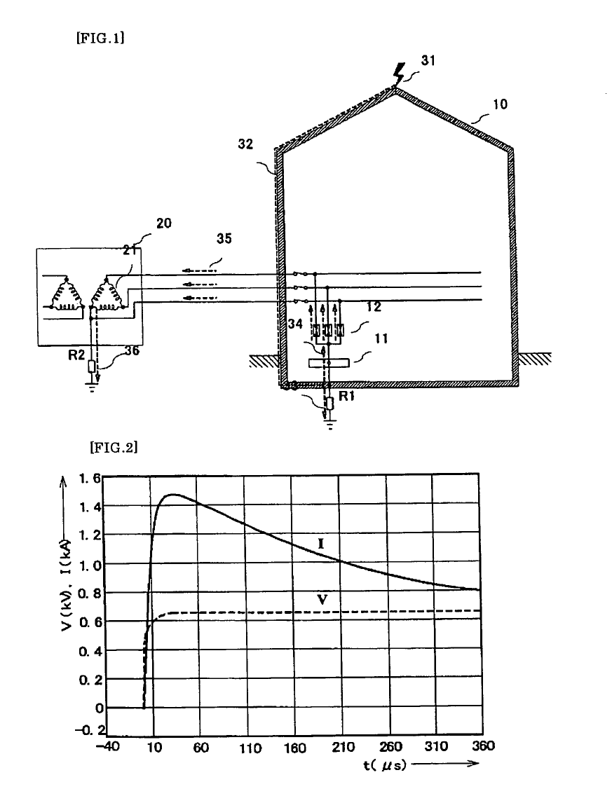

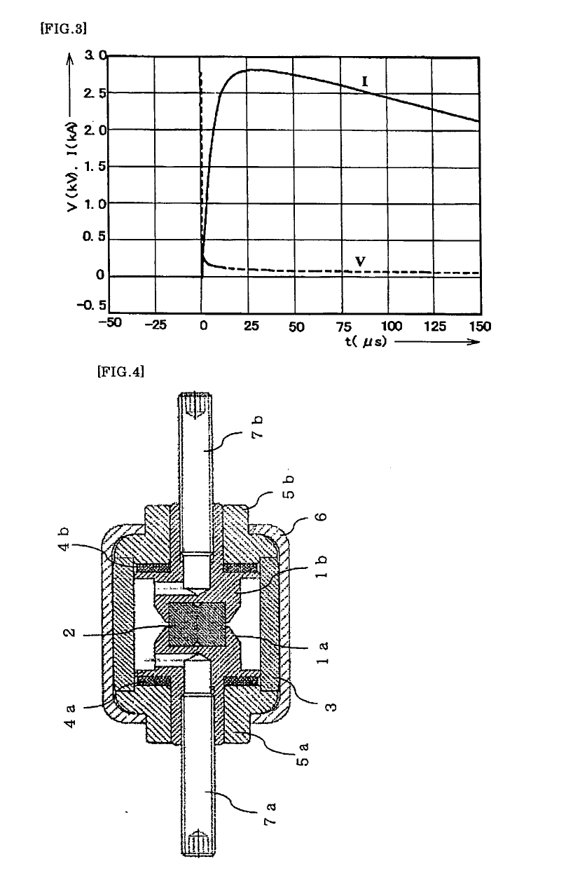

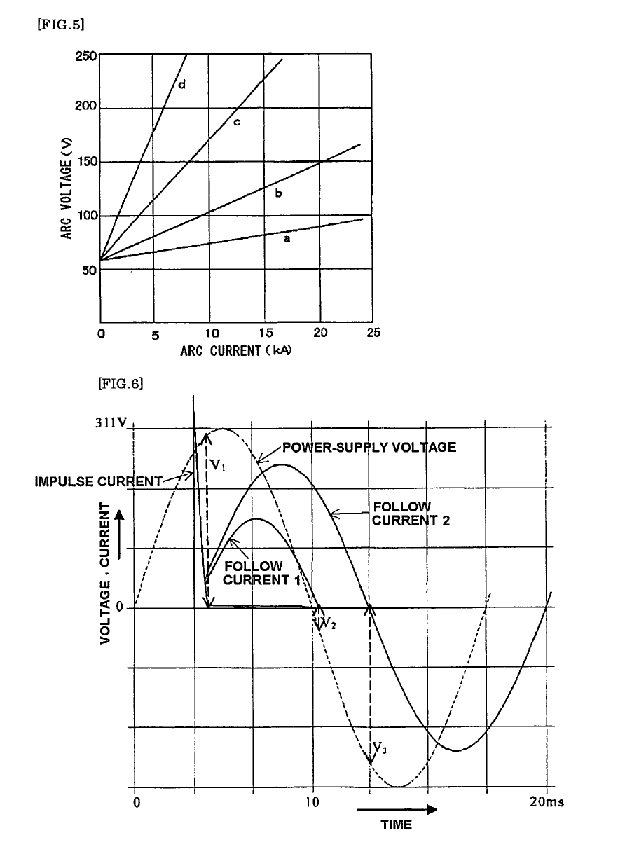

### DESCRIPTION OF REFERENCE NUMERALS AND SIGN

10 building structure, 11 bonding bar, 12 arrester, 20 distribution transformer, 21 secondary winding as described above, 31 lightning strike point, 32-36 lightning current path, R1, R2 grounding resistance, 100 spark gap, 101a, 101b electrode copper-tungsten chip, 102a, 102b electrode copper member, 103a, 103b flange, 104a, 104b terminal screw, 105a, 105b air duct, 106 arc chamber, 201-209 arc-suppressing plate, 301 insulator, 302 insulating pipe, 303a, 303b insulating ring, 304a, 304b insulating cap, 305a, 305b insulating plate, 306 metal pipe, 311 spacer ring, 312 air gap

### Best Mode for Carrying Out the Invention

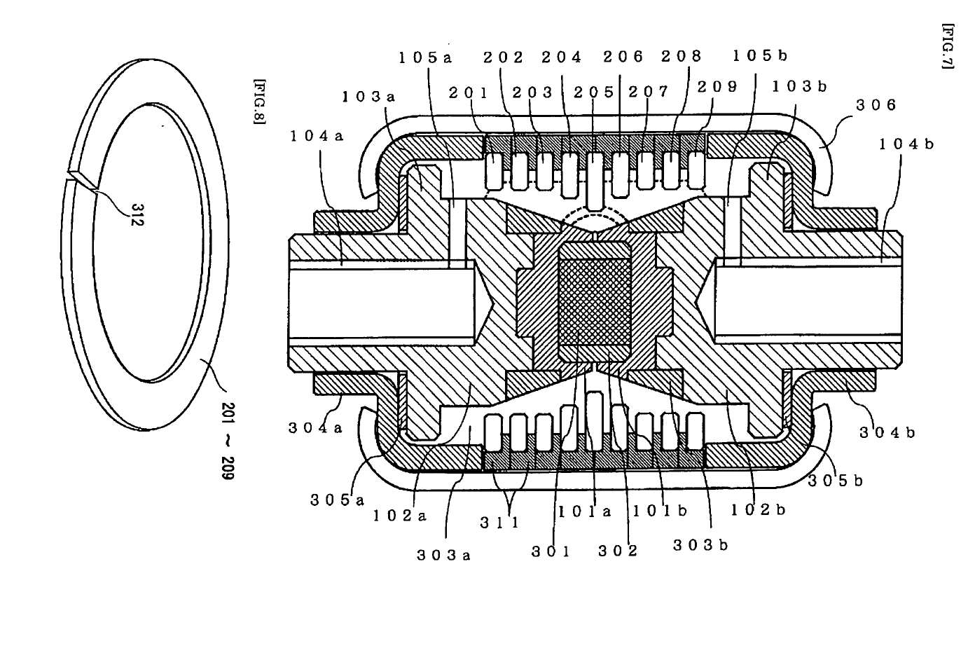

Hereinafter, the structure and function of an arrester for a low-voltage AC power circuit according to this invention will be described in detail with reference to FIGS. 7 and 8.

FIG. 7 is a longitudinal sectional view of a cylindrical sealed arrester. Its components are produced and arranged in a rotationally symmetrical manner about a center axis. Two discharge electrodes have their proximal parts made of copper members 102a, 102b, which are ordinary conductors, and have their distal end parts made of copper-tungsten chips 101a, 101b having excellent heat resistance and arc resistance. The proximal parts 102a, 102b and the distal end parts 101a, 101b are integrated without performing any troublesome processing such as soldering, since protruding parts of the distal ends parts are fitted into recessed parts provided in the proximal parts. The combination of the recessed and protruding parts of the proximal parts and the distal end parts may be the opposite. The discharge electrodes are conical in this embodiment. The discharge electrodes may be columnar, instead. The two discharge electrodes are housed in a metal pipe 306 together with an insulator 301, insulating plates 305a, 305b and insulating caps 304a, 304b. Both ends of the metal pipe are curved inward by curling processing and a pressure in the axial direction is applied to flanges 103a, 103b of the copper electrodes, thereby constructing a rigid pressure-resistant structure. The dimension of a spark gap between the electrodes is automatically defined by the difference between the thickness of the insulator 301 and the sum of the depths of the recessed parts provided on the end surfaces facing each other of the copper-tungsten chips 101a, 101b, and therefore troublesome adjustment is not necessary. There are terminal screws 104a, 104b at external led-out parts of the copper electrodes, and these connect outer conductor wires. The peripheral space around the electrodes is an arc chamber 106, which is filled with high-temperature and high-pressure gas at the time of arc discharge. Therefore, to balance the pressure with the outer air, exhaust ducts 105a, 105b are provided in the copper electrodes.

On the outer side of the insulator 301, an insulating pipe 302 made of an organic arc-suppressing insulating material, for example, polyacetal, polypropylene or the like, is arranged. The pipe 302 decomposes by the heat when arc discharge (arc a) is generated in the spark gap, and erupts arc-suppressing gas, thus shifting an arc leg point to the conical surfaces of the electrodes 101a, 101b on the outer side of the gap (arc b).

In the above-described arc chamber 106, n metal magnetic material arc-suppressing plates, in this embodiment, nine metal magnetic material arc-suppressing plates 201 to 209 are arranged which are concentric with the circular cross sections of the conical electrodes 101a, 102a and 101b, 102b. The metal magnetic material may be, for example, wrought iron. Since the arc-suppressing plate 205 at the center is arranged at the nearest position to the gap, the arc discharge path shifts outward because of the above-described attraction force that acts between the arc discharge path and the inner edge of the ring, and first, the arc-suppressing plate 205 enters the arc discharge path. On both sides thereof, the cathode and anode of arc discharge are formed (arc c).

Thus, an arc voltage of (U_{A}+U_{K}) equal to approximately 60 V is applied. Next, all the arc-suppressing plates 201 to 204 and 206 to 209 on both sides of the arc-suppressing plate 205 similarly and sequentially enter the arc discharge path. Ultimately, an arc d across all the arc-suppressing plates is formed and an arc voltage of n×(U_{A}+U_{K}) (V) is applied.

Insulating rings 303a, 303b, made of an arc-suppressing insulating material and covering the lateral sides of the two discharge electrodes 101a, 102a and 101b, 102b, prevent an arc leg point from being generated there and have an effect of promoting the extension of the arc discharge path.

The arc discharge path is maintained even when the impulse current exceeds the peak value and enters the attenuation process. However, when the current value becomes substantially zero, if the instantaneous power-supply voltage value V₁ is smaller than the arc voltage, no follow current is generated from the power supply and the arc vanishes.

When the lightning impulse current value is relatively small, the impulse current may vanish at the stage of arc a or b. In this case, since the arc voltage does not increase sufficiently, a follow current from the power supply can be generated. Also the arc due to the follow current, like the arc due to the impulse current, is shifted outward of the gap by arc-suppressing gas erupting from an insulating pipe 302 made of an organic arc-suppressing insulating material, and to the conical surfaces of the discharge electrodes 101a, 101b, causing creeping discharge (arc b). Moreover, the arc is shifted to arc c and d by the attraction force from the arc-suppressing plates.

Because of the cooling effect due to the contact of the arc with the arc-suppressing plate, and the cathode and anode voltages generated on both sides of the metal ring, the follow current is quickly reduced and vanishes near the AC voltage zero point. Since the arc resistance is sufficiently large, even if the power-supply impedance is sufficiently small, the follow current has the waveform of follow current 1 in FIG. 6 and can be intercepted within ½ cycles.

Since all of the discharge electrodes, the arc-suppressing insulating members and the arc-suppressing magnetic material rings are arranged in the rotationally symmetrical structure, wherever the first spark discharge occurs in the main electrode, the self-arc-suppressing function is the same.

To fix the positions of the metal magnetic material rings 201 to 209 and to maintain insulation from the metal pipe 306, a spacer ring 311 having a step-like cross section is used. To cool the arc and to prevent the arc from transferring to the metal pipe, using an organic arc-suppressing insulating material for the spacer ring 311 is effective.

To reduce the residual magnetism of the magnetic material metal rings 201 to 209 used as arc-suppressing plates, a part of the metal rings is cut out to provide an air gap 312 in the magnetic path, as shown in FIG. 8. If the residual magnetism of the magnetic material metal rings is reduced, change of the magnetic fluxes within the magnetic material can be increased when an impulse current flows near the magnetic material. Thus, the permeability of the magnetic material can be raised and the attraction force to the arc discharge path can be increased.

1. A spark gap arrester in which two conical or columnar discharge electrodes are arranged to face each other in a cylindrical metal case, characterized in that plural magnetic material metal rings concentric with the discharge electrodes are arranged on an outer periphery of the discharge electrodes as arc-suppressing plates.

2. The arrester as claimed in claim 1, characterized in that distal end parts and proximal parts of the two discharge electrodes are made of different conductive materials, and only the material of the distal end parts has heat resistance and arc resistance.

3. The arrester as claimed in claim 2, characterized in that a recessed part or a protruding part is provided at the proximal parts of the two discharge electrodes, and the recessed part or protruding part and the protruding part or recessed part of the discharge electrode are fitted and connected with each other.

4. The arrester as claimed in claim 2, characterized in that the two discharge electrodes are covered with an organic arc-suppressing insulating material, except for the distal end parts and the proximal parts.

5. The arrester as claimed in claim 1, characterized in that a recessed part is provided on each of end surfaces facing each other of the two discharge electrodes, and an insulator is inserted across the two recessed parts, and a spark gap dimension is defined by the difference between the sum of depths of the two recessed parts and thickness of the insulator.

6. The arrester as claimed in claim 1, characterized in that a ring-shaped disc made of an organic arc-suppressing insulating material is inserted as a spacer between the plural ring-shaped magnetic material metal discs, and the spacer has a step-like sectional shape in order to fix the positions of the arc-suppressing plates and electrically insulate each arc-suppressing plate from the metal case.

7. The arrester as claimed in claim 2, characterized in that the arc-suppressing plates are arranged over a part that is not covered with the organic arc-suppressing insulating material between the distal end parts and the proximal parts of the electrodes on both sides.

8. The arrester as claimed in claim 4, characterized in that the organic arc-suppressing insulating material is a composite material containing an inorganic reinforcement.

9. The arrester as claimed in claim 1, characterized in that an air gap is provided in order to reduce residual magnetism of the magnetic material metal rings used as arc-suppressing plates.

10. The arrester as claimed in claim 3, characterized in that the two discharge electrodes are covered with an organic arc-suppressing insulating material, except for the distal end parts and the proximal parts.

11. The arrester as claimed in claim 2, characterized in that a recessed part is provided on each of end surfaces facing each other of the two discharge electrodes, and an insulator is inserted across the two recessed parts, and a spark gap dimension is defined by the difference between the sum of depths of the two recessed parts and thickness of the insulator.

12. The arrester as claimed in claim 3, characterized in that a recessed part is provided on each of end surfaces facing each other of the two discharge electrodes, and an insulator is inserted across the two recessed parts, and a spark gap dimension is defined by the difference between the sum of depths of the two recessed parts and thickness of the insulator.

13. The arrester as claimed in claim 4, characterized in that a recessed part is provided on each of end surfaces facing each other of the two discharge electrodes, and an insulator is inserted across the two recessed parts, and a spark gap dimension is defined by the difference between the sum of depths of the two recessed parts and thickness of the insulator.

14. The arrester as claimed in claim 2, characterized in that a ring-shaped disc made of an organic arc-suppressing insulating material is inserted as a spacer between the plural ring-shaped magnetic material metal discs, and the spacer has a step-like sectional shape in order to fix the positions of the arc-suppressing plates and electrically insulate each arc-suppressing plate from the metal case.

15. The arrester as claimed in claim 3, characterized in that a ring-shaped disc made of an organic arc-suppressing insulating material is inserted as a spacer between the plural ring-shaped magnetic material metal discs, and the spacer has a step-like sectional shape in order to fix the positions of the arc-suppressing plates and electrically insulate each arc-suppressing plate from the metal case.

16. The arrester as claimed in claim 4, characterized in that a ring-shaped disc made of an organic arc-suppressing insulating material is inserted as a spacer between the plural ring-shaped magnetic material metal discs, and the spacer has a step-like sectional shape in order to fix the positions of the arc-suppressing plates and electrically insulate each arc-suppressing plate from the metal case.

17. The arrester as claimed in claim 5, characterized in that a ring-shaped disc made of an organic arc-suppressing insulating material is inserted as a spacer between the plural ring-shaped magnetic material metal discs, and the spacer has a step-like sectional shape in order to fix the positions of the arc-suppressing plates and electrically insulate each arc-suppressing plate from the metal case.

18. The arrester as claimed in claim 3, characterized in that the arc-suppressing plates are arranged over a part that is not covered with the organic arc-suppressing insulating material between the distal end parts and the proximal parts of the electrodes on both sides.

19. The arrester as claimed in claim 4, characterized in that the arc-suppressing plates are arranged over a part that is not covered with the organic arc-suppressing insulating material between the distal end parts and the proximal parts of the electrodes on both sides.

20. The arrester as claimed in claim 5, characterized in that the arc-suppressing plates are arranged over a part that is not covered with the organic arc-suppressing insulating material between the distal end parts and the proximal parts of the electrodes on both sides.
